(19) United States
(12) Patent Application Publication
(10) Pub. No.: US 2025/0286309 A1
(43) Pub. Date: Sep. 11, 2025

(54) PLUG-IN CONNECTOR

(71) Applicant: Amphenol Tuchel Industrial GmbH, Heilbronn (DE)

(72) Inventors: Peter NÜCHTER, Ulm (DE); Jan HEGI, Ostermundigen (CH); Christian LAEMMLE, Russikon (CH); Mirco WÜTHRICH, Glattfelden (CH); Marc-André BECK, Präffikon (CH)

(21) Appl. No.: 18/856,536

(22) PCT Filed: Apr. 12, 2023
(86) PCT No.: PCT/EP2023/059516

§ 371 Date: Oct. 11, 2024

(30) Foreign Application Priority Data
Apr. 14, 2022 (DE) 10 2022 109 244.5

(51) Int. Cl. H01R 13/533; H01R 13/00; H01R 24/28

(52) U.S. Cl. CPC H01R 13/533; H01R 13/005; H01R 24/28

(57) ABSTRACT

The invention relates to a plug connector designed to transmit electric power via at least two contact parts which are mounted in a contact support and to cool same while transmitting electric power, each contact part comprising a connection element which is connected to an electric line. A supply line for supplying a cooling fluid is provided in a common cooling chamber delimited by a cooling housing, and a respective tube is arranged about each line in order to convey the cooling fluid away from the cooling chamber, wherein each connection element is at least partly arranged in the cooling housing and additionally comprises a tube receiving area for receiving the respective tube, in which the corresponding electric line is received such that a line cooling region is formed for the electric line, and the connection element comprises at least one opening for fluidically coupling at least the cooling chamber. The cooling housing has at least one inlet for the cooling fluid, said inlet being connected to the supply line for the cooling fluid, and the cooling housing comprises a flow direction control means which is shaped and/or designed such that a cooling fluid entering through the inlet flows around the respective connection element in a rotating manner at least in some sections at least in the cooling chamber.

The invention relates to a plug-in connector, designed for transmitting electrical power via at least two contact parts mounted in a contact carrier and for cooling the same during the transmission of electrical power, each having a connection element to which an electrical lead is connected.

Contacts generally have at least one electrically conductive contact portion for detachable, temporary or plug-in connection to a corresponding mating contact element, and a shank portion, adjoining the contact portion, for fastening an electrical line to the contact. Such a contact, plug-in contact or high-current contact may be used on a charging plug or a charging socket, for example for charging an electrically powered vehicle. In this case, a cable is both connected to a charging station and carries a plug-in connector part in the form of a charging plug, which may be plugged into an assigned mating connector part in the form of a charging socket on a vehicle, in order thereby to establish an electrical connection between the charging station and the vehicle.

Charging currents can in principle be transmitted as direct currents or as alternating currents, although in particular charging currents and high-current ranges in the form of direct current may have a high current intensity, for example greater than 200 A, or even greater than 300 A, or even 350 A, and may result in heating of the cable and of a high-current contact connected to the cable.

During a process of charging electrical energy storage devices, such as storage batteries, heat is generated as a result of the high transmitted electrical power and electrical currents, not only on the cable by which a charging plug is connected, for example, to a charging station, but also at the charging plug and in particular within the charging plug, for example at high-current contacts via which an electrical contact is made to assigned mating contacts, for example on a charging socket on an electric vehicle, when the charging plug is inserted into the charging socket and the electrical power is transmitted.

Such high-current contacts, which are made of an electrically conductive material, for example a copper material, heat up when a charging current flows through the contacts, plug-in contacts or high-current contacts, although in principle the contacts should be dimensioned in dependence on the charging current to be transmitted, such that the contacts have a sufficient current-carrying capacity and heating at the contact elements is limited. The principle here is that the greater the charging current to be transmitted, the greater the dimensioning of the contact should be. However, there are limits to scaling of the contact element size in relation to increasing charging current, due to the associated space requirements, weight and costs. There is therefore a need to transmit a large charging current by means of a contact of comparatively small dimensions.

High charging currents are particularly important in the context of the aim of electromobility. It is only in this way that electric vehicles, or their energy storage devices, can be rapidly ‘refueled’.

A solution approach known in principle in the prior art is to passively or actively cool contacts, or high-current contacts, in order to realize the transmission of electrical power with limited heating of the power-transmitting components, even with components of smaller dimensions.

DE 10 2016 204 895 A1 discloses a power contact system for a charging plug and/or a charging socket, as well as a charging plug for coupling to a corresponding connection device and for transmitting electrical energy. The object to be achieved is to provide a charging plug by means of which higher charging currents can be transmitted without the charging plug heating up excessively.

Proposed as a solution is a power contact system for a charging plug and/or a charging socket, which has a power contact that comprises a first termination region, for galvanic connection to an electrical energy receiver, and a second termination region, for galvanic connection to a charging cable.

A cooling element is provided that is in direct contact with the second termination region of the power contact, the cooling element having a cooling-fluid inlet connection and a cooling-fluid outlet connection that is fluidically connected thereto by means of a cooling-fluid channel arranged within the cooling element. The cooling-fluid inlet connection and the cooling-fluid outlet connection are arranged in the cooling-element cover and are connected, in a manner allowing through-flow, to the cooling element, which is designed in such a manner that the cooling fluid is not in direct contact with the power contact.

US 2015/0217654 A1 from Tesla Motors discloses a charging system for an electric vehicle, comprising an electric power supply, a cable having a first and a second end, the first end being fastened to the electric power supply, the cable comprising a charging wire and a cooling line, each extending from the first end to the second end, and a connector fastened to the second end of the cable, the connector having a form factor corresponding to a charging station of the electric vehicle, the cooling line being suitable for transporting a fluid that cools the charging wire or line. The cooling line and the current-carrying charging wire or line are conveniently arranged as a line package.

A charging cable having contacts or high-current contacts that is known from DE 10 2010 007 975 B4 has a cooling line that comprises a supply line and a return line for a coolant, and that thus enables a coolant flow back and forth in the charging cable. The cooling line of DE 10 2010 007 975 B4 in this case serves, on the one hand, to dissipate heat loss generated at an energy storage device of a vehicle, but additionally also to cool the cable itself. In order to achieve the effect of cooling the charging cable, the charging cable is arranged concentrically within the cooling line and has cooling medium flowing around it.

An electrical termination body for a charging plug having a cooling means is shown in EP 3 043 421 A1. This presents an electrical termination body for a charging plug and/or a charging socket, having a first termination region, for galvanic connection to an electrical energy receiver, and a second termination region, for galvanic connection to an electrical energy source, the electrical termination body having a cooling-fluid channel realized in the electrical termination body.

The known cooling solutions for plug-in connections, charging plugs, contacts and high-current contacts are unfavorable or in need of improvement in various respects. The volume flows of cooling medium are often insufficient due to the reduced cross sections of the supply and discharge lines to and from the cooling element. The volume of the cooling element is also under-dimensioned in many cases.

A further problem of effective cooling is the frequently insufficient heat transfer between the zones and regions of increased temperature and the cooling medium. In many cases this is caused by the contact surfaces between the components, or contacts, to be cooled and the cooling elements being too small. In most cases, the components carrying the cooling medium and the components carrying the high current are separate, self-contained elements, resulting in reduced heat transfer between the two.

Many available cooling means are designed in such a manner that only partial regions of the high-current contacts are exposed to a cooling effect. Often only the regions of contact with the mating connector are cooled, or the lines receive a cooling effect. The connection portions between the lead and the contact are usually only cooled if the electrically conductive supply leads are braided-type assemblies.

In respect of safety, also, many of the cooling solutions offered for high-current contacts may not be satisfactory. The available cooling means do not offer any protection or emergency function in the event of cooling failure, for example due to defects in the cooling medium pump or faults in the supply or discharge of cooling medium.

It is therefore the object of the invention to further develop existing cooling solutions for plug-in connectors such that the aforementioned disadvantages of the prior art are at least partially reduced and the cooling performance is improved.

This object is achieved by the combination of features according to claim 1.

According to the invention, a plug-in connector is proposed, designed for transmitting electrical power via at least two contact parts mounted in a contact carrier and for cooling the same during the transmission of electrical power, each having a connection element to which an electrical lead is connected. A supply line, preferably exactly one supply line, is provided for supplying a cooling fluid into a common cooling chamber delimited by a cooling housing, and a hose is arranged around each of the leads for conveying the cooling fluid out of the cooling chamber. Further, the respective connection element is arranged, at least in some sections, in the cooling housing and comprises a hose receiver for receiving the respective hose, in which the corresponding electrical lead is received in such a manner that a lead cooling region is realized for the electrical lead. Moreover, the connection element comprises at least one opening for fluidic coupling of at least the cooling chamber. The cooling housing has at least one inlet for the cooling fluid, which is connected to the supply line for the cooling fluid. Furthermore, the cooling housing comprises a flow-direction control means that is shaped and/or realized in such a manner that a cooling fluid flowing in through the inlet flows, at least in the cooling chamber, at least in some sections, in a rotating manner around the respective connection element.

An advantage of this is that, with an appropriately cooled plug-in connector, the heat is dissipated by means of convection by a cooling fluid, allowing a significantly smaller cable diameter, or the carrying of a significantly higher current, with the same cable cross section. This is achieved by the flow-direction control means, which causes the fluid to be orientated as it flows into the cable, so that the fluid rotates from the outset. In this way, the convection, or heat absorption, of the cooling fluid from the heat transfer medium is optimized, as the fluid flows around the heat transfer medium at the highest possible speed and over the greatest possible length, thus ensuring a long dwell time.

In an advantageous embodiment variant, it is provided that the flow-direction control means distributes the cooling fluid almost uniformly to the respective connection elements, preferably with an opposing direction of rotation of the flow of the cooling fluid around the corresponding connection element. As a result, the respective connection elements are cooled approximately evenly. Further, the means that influence the flow can be configured and designed in a simpler manner.

In a preferred embodiment of the invention, exactly one supply line and exactly two electrical leads, each connected to a respective connection element, are provided, each having a hose arranged around the leads for the purpose of conveying the cooling fluid out of the cooling chamber. It is favorable in this case that the pressure drop in the plug-in connector is greatly reduced, as only half the volume flow of cooling fluid, as compared to the supply line, flows through it. In addition, due to the low pressure drop across the inlet, the overall pressure drop of the plug-in connector is reduced significantly. Moreover, this results in an approximately symmetrical temperature distribution in the contact parts and the connection elements.

In a further preferred embodiment variant, the plug-in connector according to the invention is realized in such a manner that the respective hose is fixed to the hose receiver of the corresponding connection element in such a manner that the cooling chamber and the lead cooling region are fluidically coupled by means of the opening. The cooling fluid in this case flows around the electrical lead in a rotating manner in the lead cooling region, at least in some sections. Due to a correspondingly realized opening, or coupling, of the cooling chamber and of the lead cooling region, the rotation of the cooling fluid is maintained as far as possible in the cable. This significantly improves the cooling capacity, as the path, and thus the dwell time, of the cooling fluid around the cable is lengthened.

In an exemplary embodiment of the invention, it is provided that the cooling housing is arranged in such a manner that the cooling chamber is realized at least in the region of a lead connection of the connection element for the electrical lead. An advantage of this is that a hot spot, or one of the regions of the plug-in connector that heats up the most, is cooled. Also favorable is an embodiment in which the lead connection is produced by means of a crimp connection.

In a further advantageous variant, it is provided according to the invention that the cooling housing is arranged in such a manner that the contact parts protrude/project at least in some sections out of/from the cooling housing. In this way, both contacting of the contact parts and direct cooling of the contact parts are ensured.

In a preferred embodiment of the present plug-in connector, it is also provided that the flow-direction control means comprises a projection, realized at the inlet and projecting into a flow region, that defines an inflow direction for the inflowing cooling fluid. It is furthermore advantageous if the flow-direction control means is realized in such a manner that the inflowing cooling fluid has a tangential inflow into the cooling chamber. As the fluid flows in, control of the fluid direction is implemented by means of the projection in order to generate a rotation. Due to an inlet, or flow-direction control means, realized in this way, a tangential inflow is realized for the contact parts and the connection elements, thereby increasing the speed, and correspondingly also the convection and cooling capacity.

In an exemplary embodiment of the invention, it is provided that the cooling housing, the hose and the connection element are coupled to one another by a cooling-housing adapter. Further, the protruding components are sealed by means of a suitable seal. The cooling housing adapter improves the interfacing of the components to the plug-in connector.

In a further advantageous embodiment, it is provided that the respective hose with the corresponding electrical lead is accommodated in a common outer insulation, wherein the outer insulation is preferably filled with an infill. Infill in this case refers to filling of the hose with a suitable filling material. Further, in an alternative embodiment, the supply line is accommodated in the common outer insulation. In this way, a compact and easily manageable cable is provided for the plug-in connector.

The features disclosed above can be combined in any manner, provided that this is technically possible and that they are not mutually contradictory.

Other advantageous developments of the invention are characterized in the dependent claims, or are presented in more detail below, together with the description of the preferred embodiment of the invention, with reference to the figures. In the figures:

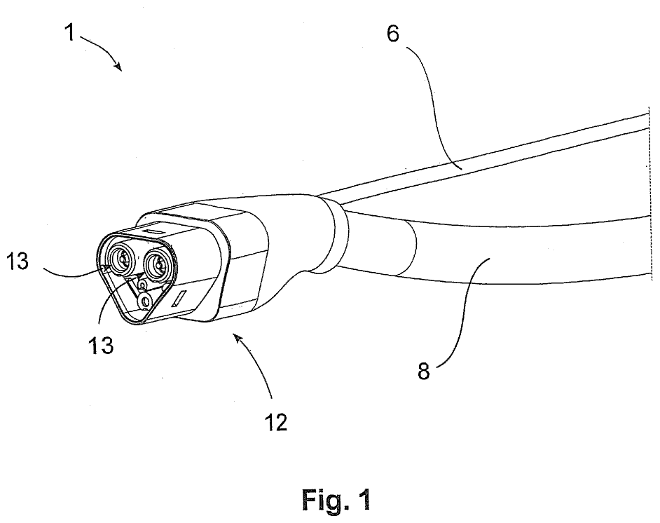

FIG. 1 shows a perspective view of a plug-in connector;

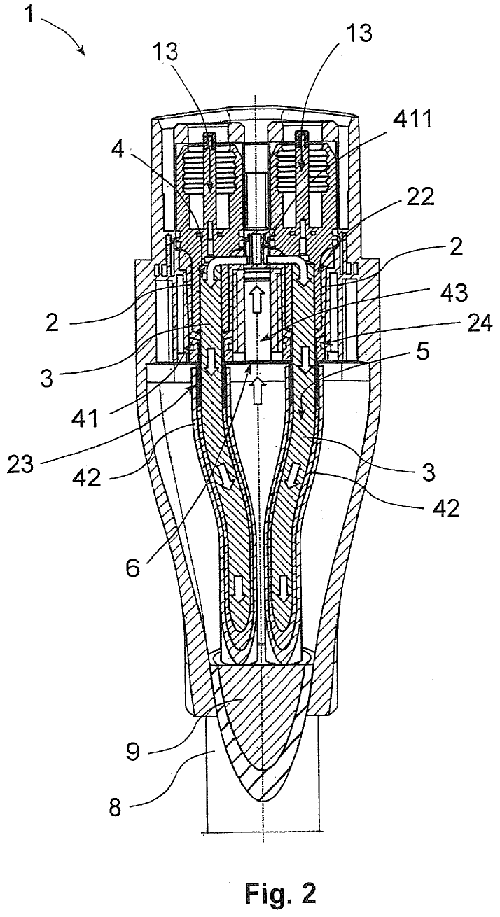

FIG. 2 shows a longitudinal section of the plug-in connector;

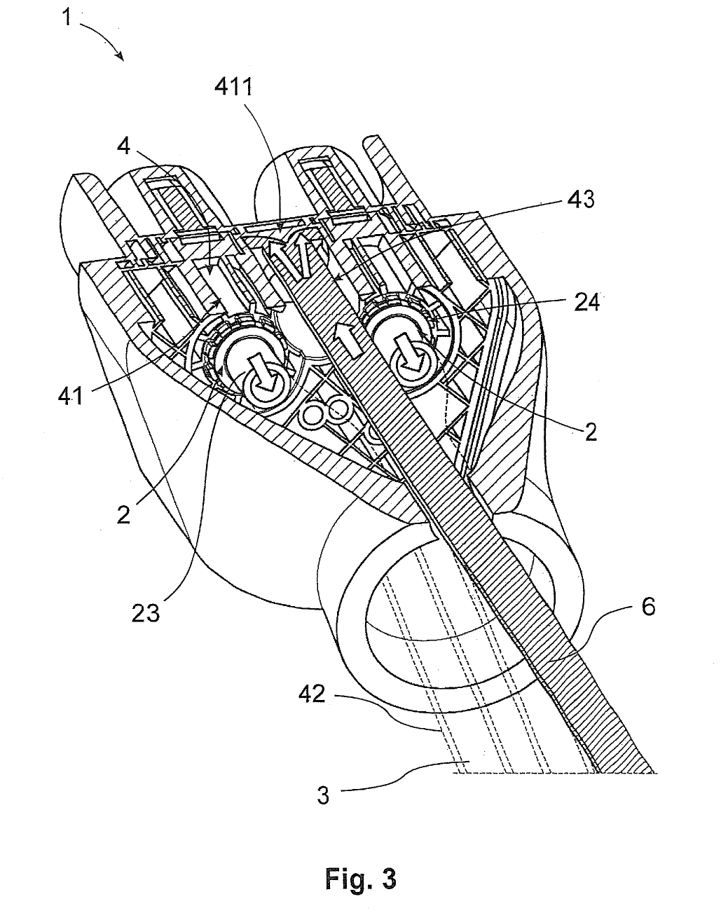

FIG. 3 shows a further longitudinal section of the plug-in connector;

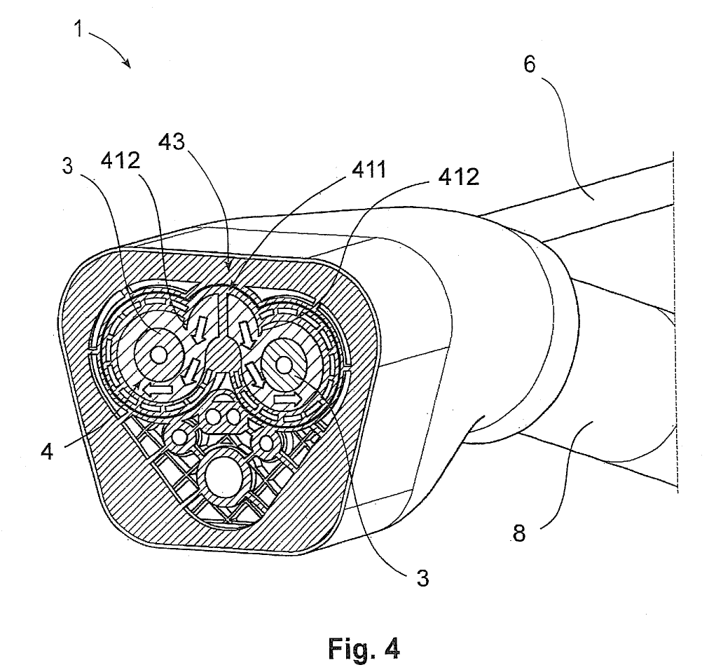

FIG. 4 shows a cross section of the plug-in connector;

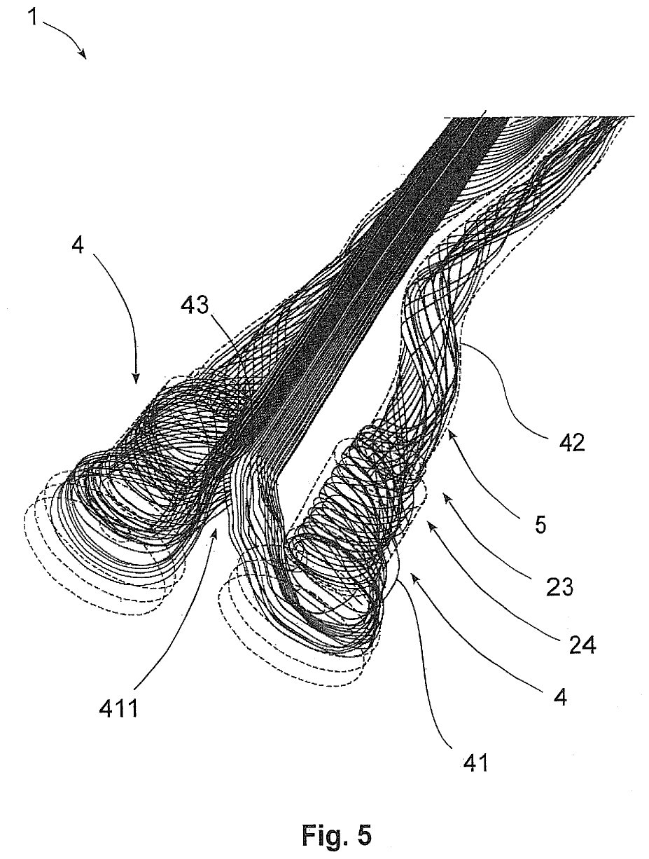

FIG. 5 shows a schematic view of a flow of a cooling fluid through the plug-in connector;

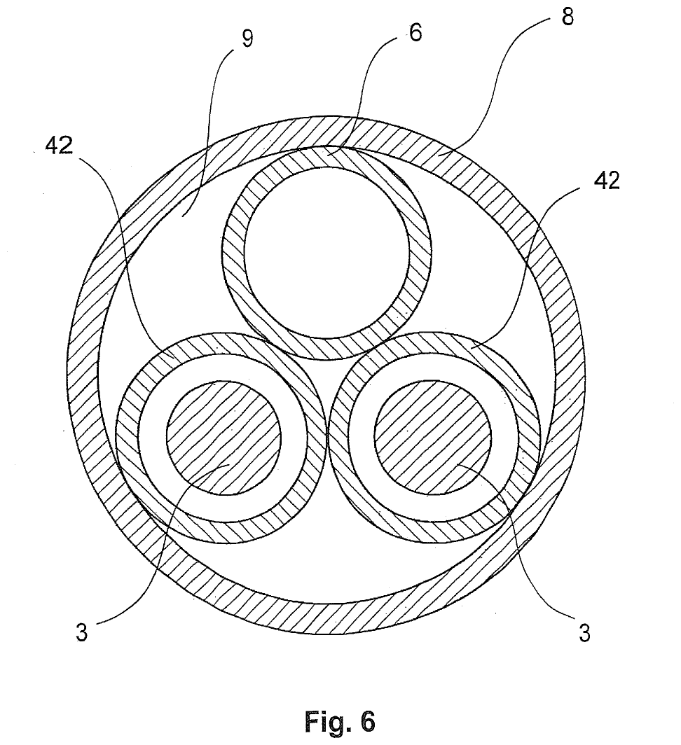

FIG. 6 shows a cross section of a common outer insulation of a plug-in connector.

The figures show schematic examples. Identical reference designations in the figures indicate identical functional and/or structural features.

FIG. 1 shows a perspective view of a plug-in connector 1 designed for transmitting electrical power via at least two contact parts 13 mounted in a contact carrier 12 and for cooling the same during the transmission of electrical power. The plug-in connector 1 comprises a cable having an outer insulation 8 and a supply line 6 for a cooling fluid.

FIG. 2 shows a longitudinal section of the plug-in connector 1 from FIG. 1, and a further longitudinal section of the plug-in connector 1 is represented in FIG. 3. FIGS. 2 and 3 are therefore described together below.

The plug-in connector 1 comprises exactly one supply line 6 for a cooling fluid, and exactly two electrical leads 3, each connected to a respective connection element 2, each having a hose 42 arranged around the leads 3 for the purpose of conveying the cooling fluid out of a cooling chamber 4. The supply line 6 is designed for feeding the cooling fluid into the common cooling chamber 4 delimited by a cooling housing 41.

Moreover, the cooling housing 41 is arranged in such a manner that the cooling chamber 4 is realized at least in the region of a lead connection 22 of the connection element 2 for the electrical lead 3. The lead connection 22 is produced by means of a crimp connection. Further, the cooling housing 41 has at least one inlet 43 for the cooling fluid, which is connected to the supply line 6 for the cooling fluid.

Furthermore, the cooling housing 41 comprises a flow-direction control means 411 that is shaped and/or realized in such a manner that a cooling fluid flowing in through the inlet 43 flows at least in some sections in the cooling chamber 4 in a rotating manner around the respective connection element 2. The flow-direction control means 411 in this case distributes the cooling fluid almost uniformly to the respective connection elements 2, with an opposing direction of rotation of the flow of the cooling fluid around the corresponding connection element 2. Further, the flow direction-control means 411 is realized in such a manner that the inflowing cooling fluid has a tangential inflow into the cooling chamber 4.

The respective connection element 2 is arranged, in some sections, in the cooling housing 41 and further comprises a hose receiver 23 for receiving the respective hose 42, in which the corresponding electrical lead 3 is received in such a manner that a lead cooling region 5 is realized for the electrical lead 3. The connection element 2 also comprises at least one opening 24 for fluidic coupling of the cooling chamber 4. The respective hose 42 is fixed to the hose receiver 23 of the corresponding connection element 2 in such a manner that the cooling chamber 4 and the lead cooling region 5 are fluidically coupled by means of the opening 24. In this way, the cooling fluid flows around the electrical lead 3 in a rotating manner in the lead cooling region 5, at least in some sections.

The cooling housing 41 is also arranged in such a manner that the contact parts 13 protrude/project at least in some sections out of/from the cooling housing 41.

The respective hose 42 is accommodated with the corresponding electrical lead 3 in the common outer insulation 8, and the outer insulation 8 is filled with an infill 9.

FIG. 4 shows a cross section of the plug-in connector 1 shown above. Further, the flow-direction control means 411 comprises a projection 412, realized at the inlet 43 and projecting into a flow region, that defines an inflow direction for the inflowing cooling fluid. The flow-direction control means 411 is realized in such a manner that the inflowing cooling fluid has a tangential inflow into the cooling chamber 4. The flow-direction control means 411 also distributes the cooling fluid almost uniformly to the respective connection elements 2, with an opposing direction of rotation of the flow of the cooling fluid around the corresponding connection element 2.

FIG. 5 shows a schematic view of a flow of a cooling fluid through the plug-in connector 1 described above. It can be seen in this figure that, due to the flow-direction control means 411 of the cooling housing 41, a cooling fluid flowing in through the inlet 43 in the cooling chamber 4 flows around the respective connection element 2 in a rotating manner. The flow-direction control means 411 in this case distributes the cooling fluid almost uniformly to the respective connection elements 2 with an opposing direction of rotation of the flow of the cooling fluid around the corresponding connection element 2. It is further shown that, as a result of the respective hose 42 being fixed to the hose receiver 23 of the corresponding connection element 2, the cooling chamber 4 and the lead cooling region 5 are fluidically coupled by means of the opening 24, and the cooling fluid flows around the electrical lead 3 in a rotating manner, at least in some sections, in the lead cooling region 5.

Represented in FIG. 6 is a cross section of a common outer insulation 8 of a plug-in connector 1, in which the respective hose 42 with the corresponding electrical lead 3 is accommodated in a common outer insulation 8, and the outer insulation 8 is filled with an infill 9. The supply line 6 is also accommodated in the common outer insulation 8.

The invention is not limited in its embodiment to the preferred exemplary embodiments given above. Rather, a number of variants, that also make use of the represented solution in fundamentally different types of embodiments, are conceivable.

### LIST OF REFERENCE DESIGNATIONS

1 plug-in connector
2 connection element
3 lead
4 cooling chamber
5 lead cooling region
6 supply line
8 outer insulation
9 infill
12 contact carrier
13 contact part
22 lead connection
23 hose receiver
24 opening
41 cooling housing
42 hose
43 inlet
411 flow-direction control means
412 projection

1. A plug-in connector, designed for transmitting electrical power via at least two contact parts mounted in a contact carrier and for cooling the same during the transmission of electrical power, each having a connection element to which an electrical lead is connected,
wherein a supply line is provided for supplying a cooling fluid into a common cooling chamber delimited by a cooling housing, and a hose is arranged around each of the leads for conveying the cooling fluid out of the cooling chamber, wherein the respective connection element is arranged, at least in some sections, in the cooling housing and further comprises a hose receiver for receiving the respective hose, in which the corresponding electrical lead is received in such a manner that a lead cooling region is realized for the electrical lead,
wherein the connection element comprises at least one opening for fluidic coupling of at least the cooling chamber,
wherein the cooling housing has at least one inlet for the cooling fluid, which is connected to the supply line for the cooling fluid,
wherein the cooling housing comprises a flow-direction control means that is shaped and/or realized in such a manner that a cooling fluid flowing in through the inlet flows, at least in the cooling chamber, at least in some sections, in a rotating manner around the respective connection element.

2. The plug-in connector as claimed in claim 1, wherein the flow-direction control means distributes the cooling fluid almost uniformly to the respective connection elements, preferably with an opposing direction of rotation of the flow of the cooling fluid around the corresponding connection element.

3. The plug-in connector as claimed in claim 1, wherein exactly one supply line and exactly two electrical leads, each connected to a respective connection element, are provided, each having a hose arranged around the leads for the purpose of conveying the cooling fluid out of the cooling chamber.

4. The plug-in connector as claimed in claim 1,
wherein the respective hose is fixed to the hose receiver of the corresponding connection element in such a manner that the cooling chamber and the lead cooling region are fluidically coupled by means of the opening, wherein the cooling fluid flows around the electrical lead in a rotating manner in the lead cooling region, at least in some sections.

5. The plug-in connector as claimed in claim 1, wherein the cooling housing is arranged in such a manner that the cooling chamber is realized at least in the region of a lead connection of the connection element for the electrical lead.

6. The plug-in connector as claimed in claim 5, wherein the lead connection is produced by means of a crimp connection.

7. The plug-in connector as claimed in claim 1,
wherein the cooling housing is arranged in such a manner that the contact parts protrude/project at least in some sections out of/from the cooling housing.

8. The plug-in connector as claimed in claim 1,
wherein the flow-direction control means comprises a projection, realized at the inlet and projecting into a flow region, that defines an inflow direction for the inflowing cooling fluid.

9. The plug-in connector as claimed in claim 1,
wherein the flow-direction control means is realized in such a manner that the inflowing cooling fluid has a tangential inflow into the cooling chamber.

10. The plug-in connector as claimed in claim 1,
wherein the cooling housing, the hose and the connection element are coupled to one another by a cooling-housing adapter.

11. The plug-in connector as claimed in claim 1,
wherein the respective hose with the corresponding electrical lead is accommodated in a common outer insulation, wherein the outer insulation is preferably filled with an infill (a filling).

12. The plug-in connector as claimed in claim 11, wherein further the supply line is accommodated in the common outer insulation.
